(19) United States
(12) Patent Application Publication
(10) Pub. No.: US 2024/0375643 A1
(43) Pub. Date: Nov. 14, 2024

(54) MITIGATION OF THIRD-PARTY INVOLVEMENT IN A REAR-END COLLISION

(71) Applicant: Volvo Car Corporation, Goteborg (SE)

(72) Inventor: Anders Lennartsson, Gothenburg (SE)

(21) Appl. No.: 18/314,593

(22) Filed: May 9, 2023

(51) Int. Cl. B60W 30/095; B60W 10/18; B60W 10/20

(52) U.S. Cl. CPC B60W 30/095; B60W 10/18; B60W 10/20; B60W 2554/00

(57) ABSTRACT

Mitigation of third-party involvement in a rear-end collision (e.g., using a computerized tool) is enabled. For example, a method can comprise: based upon a determination, according to a defined primary impact probability threshold, that a first collision between a first vehicle and a second vehicle is likely to occur, activating, by a system comprising a processor, a third party collision mitigation mode, in response to the activation of the third party collision mitigation mode, determining, by the system and according to a defined secondary impact probability threshold, whether a second collision with an object, other than the first vehicle and the second vehicle, is likely to occur, and based on the second collision being determined to be likely to occur, facilitating, by the system, an impact mitigation action determined to minimize a likelihood of occurrence of the second collision with the object.

### TECHNICAL FIELD

The disclosed subject matter relates to vehicles (e.g., transportation vehicles) and, more particularly, to mitigation of third-party involvement as a result of a rear-end collision between two or more vehicles.

### BACKGROUND

Rear-end collisions are the most frequently occurring type of collision, accounting for approximately 29% of all crashes, resulting in a substantial number of injuries and fatalities every year. Rear-end collisions, in which a leading vehicle is stopped or is moving very slowly prior to the crash, make up the majority of these crashes. When a rear-end type collision occurs between two vehicles, a leading vehicle can be pushed into an object (e.g., a third-party, such as another vehicle or a pedestrian) by a trailing vehicle (e.g., the vehicle that causes the rear-end collision).

The above-described background relating to mitigation of third-party involvement in a rear-end collision is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate vehicle passenger space identification and/or contact mitigation are described.

As alluded to above, vehicle safety systems can be improved in various ways, and various embodiments are described herein to this end and/or other ends.

According to an embodiment, a system can comprise a memory that stores computer executable components, and a processor that executes the computer executable components stored in the memory, wherein the computer executable components can comprise: a primary impact determination component that, based upon a determination, according to a defined primary impact probability threshold, that a first collision between a first vehicle and a second vehicle is likely to occur, activates a third party collision mitigation mode, a secondary impact determination component that, in response to the activation of the third party collision mitigation mode, determines, according to a defined secondary impact probability threshold, whether a second collision with an object, other than the first vehicle and the second vehicle, is likely to occur; and an impact mitigation component that, based on the second collision being determined to be likely to occur, facilitates an impact mitigation action determined to minimize a likelihood of occurrence of the second collision with the object.

According to another embodiment, a non-transitory machine-readable medium can comprise executable instructions that, when executed by a processor, facilitate performance of operations, comprising: based upon a determination, according to a defined primary impact probability threshold, that a first collision between a first vehicle and a second vehicle is likely to occur, initiating a third party collision mitigation mode, in response to the initiation of the third party collision mitigation mode, determining, according to a defined secondary impact probability threshold, whether a second collision with an object, other than the first vehicle and the second vehicle, is likely to occur, and based on the second collision being determined to be likely to occur, initiating an impact mitigation action determined to minimize a likelihood of occurrence of the second collision with the object.

According to yet another embodiment, a method can comprise: based upon a determination, according to a defined primary impact probability threshold, that a first collision between a first vehicle and a second vehicle is likely to occur, activating, by a system comprising a processor, a third party collision mitigation mode, in response to the activation of the third party collision mitigation mode, determining, by the system and according to a defined secondary impact probability threshold, whether a second collision with an object, other than the first vehicle and the second vehicle, is likely to occur; and based on the second collision being determined to be likely to occur, facilitating, by the system, an impact mitigation action determined to minimize a likelihood of occurrence of the second collision with the object.

### BRIEF DESCRIPTION OF DRAWINGS

FIG. 1 illustrates a block diagram of an exemplary system in accordance with one or more embodiments described herein.

FIG. 2 illustrates a block diagram of example, non-limiting computer executable components in accordance with one or more embodiments described herein.

FIG. 3 illustrates a block diagram of example, non-limiting vehicle electronic systems/devices in accordance with one or more embodiments described herein.

FIG. 4 illustrates a block diagram of example, non-limiting external devices in accordance with one or more embodiments described herein.

FIG. 5 illustrates an example, non-limiting scenario in accordance with one or more embodiments described herein.

FIG. 6 illustrates an example, non-limiting scenario in accordance with one or more embodiments described herein.

FIG. 7 illustrates an example, non-limiting scenario in accordance with one or more embodiments described herein.

FIG. 8 illustrates an example, non-limiting scenario in accordance with one or more embodiments described herein.

FIG. 9 illustrates an example, non-limiting scenario in accordance with one or more embodiments described herein.

FIG. 10 illustrates an example, non-limiting scenario in accordance with one or more embodiments described herein.

FIGS. 11A-11B illustrate an example, non-limiting scenario in accordance with one or more embodiments described herein.

FIG. 12 illustrates an example, non-limiting scenario in accordance with one or more embodiments described herein.

FIG. 13 illustrates an example, non-limiting scenario in accordance with one or more embodiments described herein.

FIG. 14 illustrates an example, non-limiting scenario in accordance with one or more embodiments described herein.

FIG. 15 illustrates an example, non-limiting scenario in accordance with one or more embodiments described herein.

FIG. 16 illustrates an example, non-limiting scenario in accordance with one or more embodiments described herein.

FIGS. 17A-17B illustrate an example, non-limiting scenario in accordance with one or more embodiments described herein.

FIG. 18 illustrates an example, non-limiting scenario in accordance with one or more embodiments described herein.

FIG. 19 illustrates an example, non-limiting scenario in accordance with one or more embodiments described herein.

FIG. 20 illustrates a block flow diagram for a process associated with mitigation of third-party involvement in a rear-end collision in accordance with one or more embodiments described herein.

FIG. 21 is an example, non-limiting computing environment in which one or more embodiments described herein can be implemented.

FIG. 22 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments the described herein.

The computer processing systems, computer-implemented methods, apparatus and/or computer program products described herein employ hardware and/or software to solve problems that are highly technical in nature (e.g., identify vehicle passenger space and/or mitigate contact), that are not abstract and cannot be performed as a set of mental acts by a human.

Various embodiments described herein enable minimization of damage to a third-party, for instance, when a collision is about to occur. If a vehicle described herein detects that there is an elevated risk for being a party to a rear end collision, the vehicle can activate a collision mitigation mode and/or one or more safety features to avoid involving a third party in the accident.

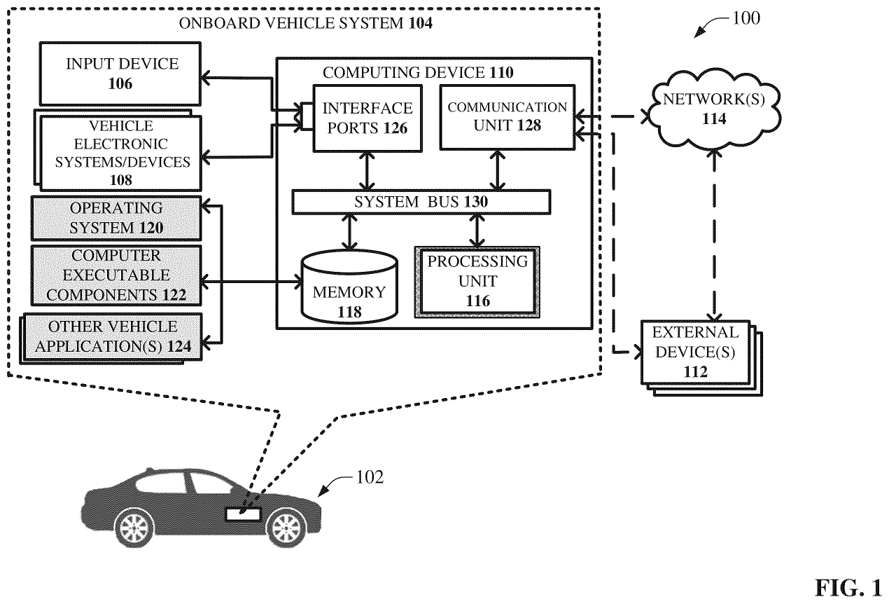

Turning now to FIG. 1, there is illustrated an example, non-limiting system 100 in accordance with one or more embodiments herein. System 100 can comprise a computerized tool, which can be configured to perform various operations relating to mitigation of third-party involvement in a rear-end collision. In accordance with various exemplary embodiments, system 100 can be deployed on or within a vehicle 102, (e.g., an automobile, as shown in FIG. 1). Although FIG. 1 depicts the vehicle 102 as an automobile, the architecture of the system 100 is not so limited. For instance, the system 100 described herein can be implemented with a variety of types of vehicles 102. Example vehicles 102 that can incorporate the exemplary system 100 can include, but are not limited to: automobiles (e.g., autonomous vehicles or semi-autonomous vehicles), airplanes, trains, motorcycles, carts, trucks, semi-trucks, buses, boats, recreational vehicles, helicopters, jets, electric scooters, electric bicycles, a combination thereof, and/or the like. It is additionally noted that the system 100 can be implemented in a variety of types of automobiles, such as battery electric vehicles, hybrid vehicles, plug-in hybrid vehicles, internal combustion engine vehicles, or other suitable types of vehicles.

As shown in FIG. 1, the system 100 can comprise one or more onboard vehicle systems 104, which can comprise one or more input devices 106, one or more other vehicle electronic systems and/or devices 108, and/or one or more computing devices 110. Additionally, the system 100 can comprise one or more external devices 112 that can be communicatively and/or operatively coupled to the one or more computing devices 110 of the one or more onboard vehicle systems 104 either via one or more networks 114 and/or a direct electrical connection (e.g., as shown in FIG. 1). In various embodiments, one or more of the onboard vehicle system 104, input devices 106, vehicle electronic systems and/or devices 108, computing devices 110, external devices 112, and/or networks 114 can be communicatively or operably coupled (e.g., over a bus or wireless network) to one another to perform one or more functions of the system 100.

The one or more input devices 106 can display one or more interactive graphic entity interfaces (“GUIs”) that facilitate accessing and/or controlling various functions and/or application of the vehicle 102. The one or more input devices 106 can display one or more interactive GUIs that facilitate accessing and/or controlling various functions and/or applications. The one or more input devices 106 can comprise one or more computerized devices, which can include, but are not limited to: personal computers, desktop computers, laptop computers, cellular telephones (e.g., smartphones or mobile devices), computerized tablets (e.g., comprising a processor), smart watches, keyboards, touchscreens, mice, a combination thereof, and/or the like. An entity or user of the system 100 can utilize the one or more input devices 106 to input data into the system 100. Additionally, the one or more input devices 106 can comprise one or more displays that can present one or more outputs generated by the system 100 to an entity. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

For example, the one or more input devices 106 can comprise a touchscreen that can present one or more graphical touch controls that can respectively correspond to a control for a function of the vehicle 102, an application, a function of the application, interactive data, a hyperlink to data, and the like, wherein selection and/or interaction with the graphical touch control via touch activates the corresponding functionality. For instance, one or more GUIs displayed on the one or more input devices 106 can include selectable graphical elements, such as buttons or bars corresponding to a vehicle navigation application, a media application, a phone application, a back-up camera function, a car settings function, a parking assist function, and/or the like. In some implementations, selection of a button or bar corresponding to an application or function can result in the generation of a new window or GUI comprising additional selectable icons or widgets associated with the selected application. For example, selection of one or more selectable options herein can result in generation of a new GUI or window that includes additional buttons or widgets with one or more selectable options. The type and appearance of the controls can vary. For example, the graphical touch controls can include icons, symbols, widgets, windows, tabs, text, images, a combination thereof, and/or the like.

The one or more input devices 106 can comprise suitable hardware that registers input events in response to touch (e.g., by a finger, stylus, gloved hand, pen, etc.). In some implementations, the one or more input devices 106 can detect the position of an object (e.g., by a finger, stylus, gloved hand, pen, etc.) over the one or more input devices 106 within close proximity (e.g., a few centimeters) to touchscreen without the object touching the screen. As used herein, unless otherwise specified, reference to “on the touchscreen” refers to contact between an object (e.g., an entity's finger) and the one or more input devices 106 while reference to “over the touchscreen” refers to positioning of an object within close proximity to the touchscreen (e.g., a defined distance away from the touchscreen) yet not contacting the touchscreen.

The type of the input devices 106 can vary and can include, but is not limited to: a resistive touchscreen, a surface capacitive touchscreen, a projected capacitive touchscreen, a surface acoustic wave touchscreen, and an infrared touchscreen. In various embodiments, the one or more input devices 106 can be positioned on the dashboard of the vehicle 102, such as on or within the center stack or center console of the dashboard. However, the position of the one or more input devices 106 within the vehicle 102 can vary.

The one or more other vehicle electronic systems and/or devices 108 can include one or more additional devices and/or systems (e.g., in addition to the one or more input devices 106 and/or computing devices 110) of the vehicle 102 that can be controlled based at least in part on commands issued by the one or more computing devices 110 (e.g., via one or more processing units 116) and/or commands issued by the one or more external devices 112 communicatively coupled thereto. For example, the one or more other vehicle electronic systems and/or devices 108 can comprise: seat motors, seatbelt system(s), airbag system(s), display(s), infotainment system(s), speaker(s), a media system (e.g., audio and/or video), a back-up camera system, a heating, ventilation, and air conditioning (“HVAC”) system, a lighting system, a cruise control system, a power locking system, a navigation system, an autonomous driving system, a vehicle sensor system, telecommunications system, a combination thereof, and/or the like. Other example other vehicle electronic systems and/or devices 108 can comprise one or more sensors, which can comprise distance sensors, seats, seat position sensor(s), collision sensor(s), odometers, altimeters, speedometers, accelerometers, engine features and/or components, fuel meters, flow meters, cameras (e.g., digital cameras, heat cameras, infrared cameras, and/or the like), lasers, radar systems, lidar systems, microphones, vibration meters, moisture sensors, thermometers, seatbelt sensors, wheel speed sensors, a combination thereof, and/or the like. For instance, a speedometer of the vehicle 102 can detect the vehicle 102's traveling speed. Further, the one or more sensors can detect and/or measure one or more conditions outside the vehicle 102, such as: whether the vehicle 102 is traveling through a rainy environment, whether the vehicle 102 is traveling through winter conditions (e.g., snowy and/or icy conditions), whether the vehicle 102 is traveling through very hot conditions (e.g., desert conditions), and/or the like. Example navigational information can include, but is not limited to: the destination of the vehicle 102, the position of the vehicle 102, the type of vehicle 102, the speed of the vehicle 102, environmental conditions surrounding the vehicle 102, the planned route of the vehicle 102, traffic conditions expected to be encountered by the vehicle 102, operational status of the vehicle 102, a combination thereof, and/or the like.

The one or more computing devices 110 can facilitate executing and controlling one or more operations of the vehicle 102, including one or more operations of the one or more input devices 106, and the one or more other vehicle electronic systems/devices 108 using machine-executable instructions. In this regard, embodiments of system 100 and other systems described herein can include one or more machine-executable components embodied within one or more machines (e.g., embodied in one or more computer readable storage media associated with one or more machines, such as computing device 110). Such components, when executed by the one or more machines (e.g., processors, computers, virtual machines, etc.) can cause the one or more machines to perform the operations described.

For example, the one or more computing devices 110 can include or be operatively coupled to at least one memory 118 and/or at least one processing unit 116. The one or more processing units 116 can be any of various available processors. For example, dual microprocessors and other multiprocessor architectures also can be employed as the processing unit 116. In various embodiments, the at least one memory 118 can store software instructions embodied as functions and/or applications that when executed by the at least one processing unit 116, facilitate performance of operations defined by the software instruction. In the embodiment shown, these software instructions can include one or more operating system 120, one or more computer executable components 122, and/or one or more other vehicle applications 124. For example, the one or more operating systems 120 can act to control and/or allocate resources of the one or more computing devices 110. It is to be appreciated that the claimed subject matter can be implemented with various operating systems or combinations of operating systems.

The one or more computer executable components 122 and/or the one or more other vehicle applications 124 can take advantage of the management of resources by the one or more operating systems 120 through program modules and program data also stored in the one or more memories 118. The one or more computer executable components 122 can provide various features and/or functionalities that can facilitate prevention of third party involvement in a rear end type accident herein. Example, other vehicle applications 124 can include, but are not limited to: a navigation application, a media player application, a phone application, a vehicle settings application, a parking assistance application, an emergency roadside assistance application, a combination thereof, and/or the like. The features and functionalities of the one or more computer executable components 122 are discussed in greater detail infra.

The one or more computing devices 110 can further include one or more interface ports 126, one or more communication units 128, and a system bus 130 that can communicatively couple the various features of the one or more computing devices 110 (e.g., the one or more interface ports 126, the one or more communication units 128, the one or more memories 118, and/or the one or more processing units 116). The one or more interface ports 126 can connect the one or more input devices 106 (and other potential devices) and the one or more other vehicle electronic systems/devices 108 to the one or more computing devices 110. For example, the one or more interface ports 126 can include, a serial port, a parallel port, a game port, a universal serial bus (“USB”) and the like.

The one or more communication units 128 can include suitable hardware and/or software that can facilitate connecting one or more external devices 112 to the one or more computing devices 110 (e.g., via a wireless connection and/or a wired connection). For example, the one or more communication units 128 can be operatively coupled to the one or more external devices 112 via one or more networks 114. The one or more networks 114 can include wired and/or wireless networks, including but not limited to, a personal area network (“PAN”), a local area network (“LAN”), a cellular network, a wide area network (“WAN”, e.g., the Internet), and the like. For example, the one or more external devices 112 can communicate with the one or more computing devices 110 (and vice versa) using virtually any desired wired or wireless technology, including but not limited to: wireless fidelity (“Wi-Fi”), global system for mobile communications (“GSM”), universal mobile telecommunications system (“UMTS”), worldwide interoperability for microwave access (“WiMAX”), enhanced general packet radio service (enhanced “GPRS”), fifth generation (“5G”) communication system, sixth generation (“6G”) communication system, third generation partnership project (“3GPP”) long term evolution (“LTE”), third generation partnership project 2 (“3GPP2”) ultra-mobile broadband (“UMB”), high speed packet access (“HSPA”), Zigbee and other 802.XX wireless technologies and/or legacy telecommunication technologies, near field communication (“NFC”) technology, BLUETOOTH®, Session Initiation Protocol (“SIP”), ZIGBEE®, RF4CE protocol. WirelessHART protocol, 6LoWPAN (IPv6 over Low power Wireless Area Networks), Z-Wave, an ANT, an ultra-wideband (“UWB”) standard protocol, and/or other proprietary and non-proprietary communication protocols. In this regard, the one or more communication units 128 can include software, hardware, or a combination of software and hardware that is configured to facilitate wired and/or wireless communication between the one or more computing devices 110 and the one or more external devices 112. While the one or more communication units 128 are shown for illustrative clarity as a separate unit that is not stored within memory 118, it is to be appreciated that one or more (software) components of the communication unit can be stored in memory 118 and include computer executable components.

The one or more external devices 112 can include any suitable computing device comprising a display and input device (e.g., a touchscreen) that can communicate with the one or more computing devices 110 comprised within the onboard vehicle system 104 and interface with the one or more computer executable components 122 (e.g., using a suitable application program interface (“API”)). For example, the one or more external devices 112 can include, but are not limited to: a mobile phone, a smartphone, a tablet, a personal computer (“PC”), a digital assistant (“PDA”), a heads-up display (“HUD”), virtual reality (“VR”) headset, an augmented reality (“AR”) headset, or another type of wearable computing device, a desktop computer, a laptop computer, a computer tablet, a combination thereof, and the like.

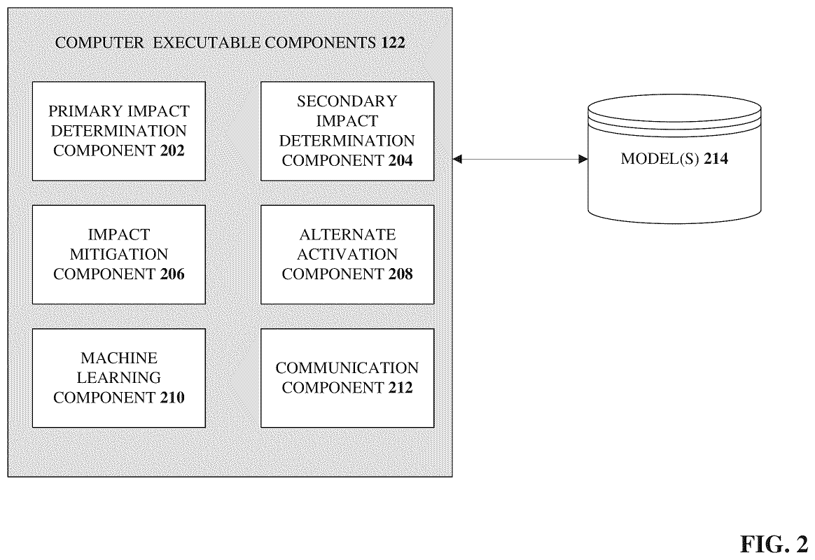

FIG. 2 illustrates a block diagram of example, non-limiting computer executable components 122 that can facilitate mitigation of third-party involvement in a rear-end collision in accordance with one or more embodiments described herein. Repetitive description of like elements employed in other embodiments described herein is omitted for sake of brevity. As shown in FIG. 2, the one or more computer executable components 122 can comprise primary impact determination component 202, secondary impact determination component 204, impact mitigation component 206, alternate activation component 208, machine learning component 210, and/or communication component 212. In various embodiments, the computer executable components can be communicatively coupled to and/or can further comprise machine learning based model(s) 214, which can be stored in memory 118.

In various embodiments, the primary impact determination component 202 can, upon a determination (e.g., according to a defined primary impact probability threshold) that a first collision between a first vehicle (e.g., vehicle 102 comprising the system 100) and a second vehicle (e.g., vehicle 506) is likely to occur, activate a third party collision mitigation mode. Such a defined primary impact probability threshold can be predefined, or can be determined, for instance, using machine learning (e.g., via the machine learning component 210) applied to past collisions between other vehicles and/or objects. In one or more embodiments, the primary impact determination component 202 can determine a location of a first vehicle (e.g., vehicle 102) using a global positioning system (GPS) sensor (e.g., of the vehicle electronic systems/devices 108) or another suitable sensor, device, or component of the vehicle 102. In various embodiments, the primary impact determination component 202 can determine a location (e.g., a second location) of the second vehicle (e.g., vehicle 506) using one or more distance sensors 302. Further, a plurality of readings of the distance sensors 302 over time, compared (e.g., via the primary impact determination component 202) to a speed of the first vehicle (e.g., vehicle 102), can be utilized (e.g., via the primary impact determination component 202) in order to determine a speed differential between the first vehicle and the second vehicle. In some implementations, the primary impact determination component 202 can further determine (e.g., according to a defined primary impact probability threshold) that the first collision between the first vehicle (e.g., vehicle 102) and the second vehicle (e.g., vehicle 506) is likely to occur based on can be based on one or more of a variety of factors, such as a type of the second vehicle (e.g., as determined using a defined machine vision algorithm), distance between vehicles, vehicle speed, vehicle trajectories, pedestrian position, pedestrian trajectory, quantity of pedestrians, time of day, road conditions, tire size, maintenance history, or other suitable factors.

In some embodiments, the primary impact determination component 202 can further determine (e.g., according to a defined primary impact probability threshold) whether the first collision between the first vehicle and the second vehicle is likely to occur based on a road condition applicable to the first vehicle or the second vehicle. In this regard, a safe distance between a vehicle 102 and vehicle 506 to avoid a rear-end collision can vary depending on the road condition (e.g., of a street 510) as determined by the vehicle 102 via the vehicle electronic systems/devices 108. Such road conditions can comprise one or more of dry pavement, wet pavement, snow-covered pavement, icy road, gravel road, uneven road surfaces, a construction zone, a low-visibility zone, or other suitable road conditions. For example, such a safe distance can be determined (e.g., via the primary impact determination component 202) to be larger if the road condition comprises snow cover or wet from rain as compared to a safe distance on a dry, warm, sunny day.

In another embodiment, the primary impact determination component 202 can further determine (e.g., according to a defined primary impact probability threshold) whether the first collision between the first vehicle and the second vehicle is likely to occur based on historical accident data associated with a location applicable to the vehicle 102. For example, some intersections may have a relatively high occurrence of rear end collisions (e.g., relative to an average occurrence of rear end collisions) according to defined deviations from average. In this regard, if the vehicle 102 is approaching such an intersection, the third party collision mitigation mode can be activated (e.g., via the impact mitigation component 206 and/or the alternate activation component 208) once the vehicle 102 is within a threshold distance of the intersection (e.g., based on a trajectory or route information applicable to the vehicle 102). Such historical information can be communicated to the vehicle 102 (e.g., via the communication component 212) from a network 114 (e.g., a cloud-based network) and/or stored locally on the vehicle 102 itself (e.g., in memory 118). Further, the impact determination component 206 can modify a safe braking distance (e.g., for the vehicle 506) based on degree of risk at a certain location. For instance, the impact determination component 206 can apply a weight to modify the safe distance based on the frequency of collisions at a given location.

In various embodiments, the secondary impact determination component 204 can, in response to the activation of the third party collision mitigation mode, determine (e.g., according to a defined secondary impact probability threshold) whether a second collision with an object, other than the first vehicle (e.g., vehicle 102) and the second vehicle (e.g., vehicle 506), is likely to occur (e.g., as a result of being pushed by the vehicle 506 due to a rear-end collision between the vehicle 102 and the vehicle 506). Such a defined secondary impact probability threshold can be predefined, or can be determined, for instance, using machine learning (e.g., via the machine learning component 210) applied to past collisions between other vehicles and/or objects. It is noted that the object can comprise one or more of a variety of objects, such as a third vehicle, other than the first vehicle and other than the second vehicle, a pedestrian (e.g., a person), an animal or other living object, or another suitable object. In various embodiments, such a second collision can be determined (e.g., via the secondary impact determination component 204) to be likely to occur based on a defined safe distance threshold (e.g., based on one or more of a variety of factors, such as a type of the second vehicle (e.g., vehicle 506), as determined using a defined machine vision algorithm, distance between vehicles, vehicle speed, vehicle trajectories, pedestrian position, pedestrian trajectory, quantity of pedestrians, time of day, road conditions, tire size, maintenance history, or other suitable factors) being exceeded (e.g., distance between vehicles is less than or equal to the safe distance threshold). Such a threshold can be defined, or can be determined, for instance, using machine learning (e.g., via the machine learning component 210) applied to past collisions between other vehicles and/or objects.

In various embodiments, the impact mitigation component 206 can, based on the second collision being determined (e.g., according to a defined secondary impact probability threshold) to be likely to occur, facilitate an impact mitigation action determined to minimize a likelihood of occurrence of the second collision with the object. It is noted that, in various embodiments, the impact mitigation action can be determined (e.g., via the impact mitigation component 206) based on a trajectory that avoids a plurality of objects. Such an impact mitigation action can comprise one or more of a variety of impact mitigation actions. In one or more embodiments, the impact mitigation action can comprise adjustment of a steering mechanism (e.g., of steering systems(s) 312) of the first vehicle (e.g., vehicle 102) to facilitate movement of the vehicle 102 along a predicted trajectory, away from the object. Additionally, or alternatively, the impact mitigation can comprise disengagement of a braking system of the first vehicle (e.g., vehicle 102). Additionally, or alternatively, the impact mitigation can comprise an acceleration (e.g., via the propulsion system(s) 314) of the first vehicle (e.g., vehicle 102). Additionally, or alternatively, the impact mitigation can comprise movement (e.g., via the propulsion system(s) 314) of the first vehicle (e.g., vehicle 102) away from a defined area. Additionally, or alternatively, the impact mitigation can comprise an alert transmitted (e.g., via the communication component 212) external to the vehicle 102 (e.g., a first vehicle). Such an alert can comprise an audible warning (e.g., broadcasted via speaker 308 or horn external to the vehicle 102), or a visual warning (e.g., via flashing lights 304 of the vehicle 102). Additionally, or alternatively, the impact mitigation action can comprise an alert transmitted (e.g., via the communication component 212) to a wearable device 404 or mobile device 402 applicable to a pedestrian or other person or object. In this regard, the impact mitigation action can comprise transmission (e.g., via the communication component 212) of the alert. It is noted that, in various implementations, the mobile device 402 can be configured to display a visual representation of the alert, for instance, if a screen of the mobile device 402 is unlocked when the alert data is received by the mobile device 402. However, the mobile device 402 can be configured not to display a visual representation of the alert, for instance, if a screen of the mobile device 402 is locked when the alert data is received by the mobile device 402. In this regard, the mobile device 402 can, in some implementations, generate an audible alert based on the alert data regardless of whether the screen of the mobile device 402 is unlocked, though in other implementations, the mobile device 402 can be configured not to generate the audible alert, for instance, if a screen of the mobile device 402 is locked when the alert data is received by the mobile device 402.

Determination of a suitable impact mitigation action (e.g., via the impact mitigation component 206) can be based on one or more of a variety of factors, such as distance between vehicles, vehicle speed, vehicle trajectories, pedestrian position, pedestrian trajectory, quantity of pedestrians, time of day, road conditions, type of vehicle, or other suitable factors. In some embodiments, a suitable impact mitigation action can be determined (e.g., by the impact mitigation component 206) using a defined lookup table, or can be determined, for instance, using machine learning (e.g., via the machine learning component 210) applied to past collisions between other vehicles and/or objects.

In various embodiments, the alternate activation component 208 can activate the third party collision mitigation mode in response to an alternate activation condition being determined (by the alternate activation component 208) to be satisfied. Such an alternate activation condition can comprise one or more of a variety of alternate activation conditions. In one or more embodiments, the alternate activation condition can comprise a deceleration of the first vehicle (e.g., vehicle 102). Additionally, or alternatively, the alternate activation condition can comprise the first vehicle (e.g., vehicle 102) being determined to be within a threshold distance of a defined location. Additionally, or alternatively, the alternate activation condition can comprise the first vehicle being determined (e.g., according to a defined braking probability threshold) to be likely to initiate a future braking action, or another suitable alternate activation condition. Such a defined braking probability threshold can be predefined, or can be determined, for instance, using machine learning (e.g., via the machine learning component 210) applied to past collisions between other vehicles and/or objects. Such a determination can be based on a location of the vehicle 102, a proximity of the vehicle 102 to an intersection, a proximity of the vehicle 102 to another vehicle or object, a road condition, or another suitable factor. Additionally, or alternatively, the alternate activation condition can be based on a defined route applicable to the first vehicle. In some embodiments, the alternate activation condition can be determined (e.g., by the alternate activation component 208) using a defined lookup table, or can be determined, for instance, using machine learning (e.g., via the machine learning component 210) applied to past collisions between other vehicles and/or objects.

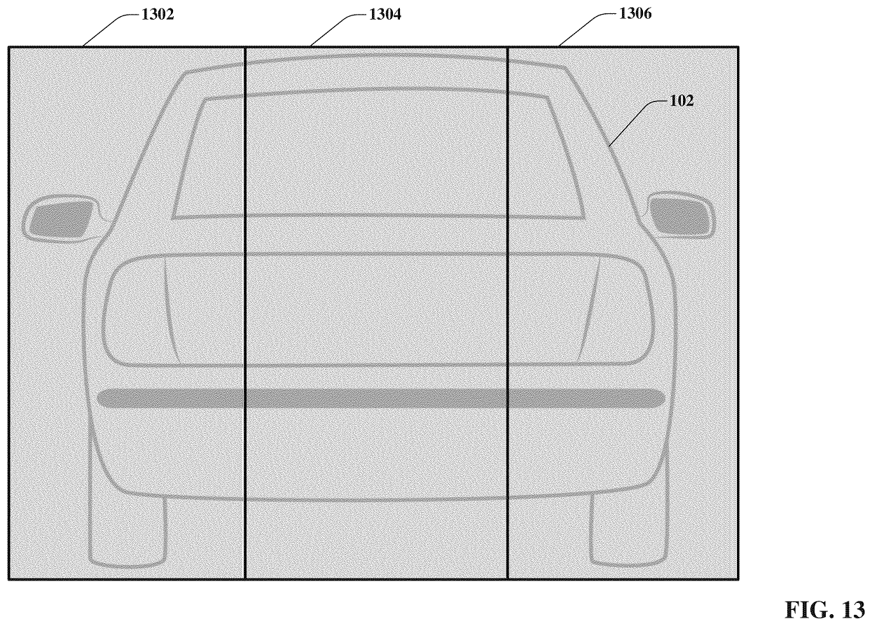

In various embodiments, the communication component 212 can, based on the first collision and the second collision being determined (e.g., via the primary impact determination component 202 and/or secondary impact determination component 204) to be likely to occur, transmit request data, representative of a collision request, from the first vehicle (e.g., vehicle 102) to the second vehicle (e.g., vehicle 506). In this regard, the collision request can comprise a request for the second vehicle (e.g., vehicle 506) to contact the first vehicle (e.g., vehicle 102) at a designated zone of a plurality of zones of the first vehicle (e.g., see FIG. 13).

In various embodiments, the communication component 212 can, based on the second collision being determined (e.g., via the secondary impact determination component 204 according to a defined secondary impact probability threshold) to be likely to occur, transmit alert data representative of an alert to a mobile device (e.g., mobile device 402 or wearable device 404) associated with the object. In this regard, the impact mitigation action can comprise transmission (e.g., via the communication component 212) of the alert.

In various embodiments, the communication component 212 can, based on the second collision being determined (e.g., via the secondary impact determination component 204 according to a defined secondary impact probability threshold) to be likely to occur, transmit alert data representative of an alert to a traffic signal (e.g., traffic signal 406) applicable to the object. In this regard, the traffic signal 406 can be configured to display a corresponding signal, such as a do-not-cross signal, danger signal, visual signal, color-coded signal, or another suitable signal intended to alert the pedestrian 1202 or another entity/object to a potential collision (e.g., a second collision herein).

In various embodiments, the machine learning component 210 can, using machine learning applied to past first collusions other than the first collision or to past second collisions other than the second collision, generate a collision mitigation model (e.g., of the model(s) 214). In this regard, the impact mitigation component 206 can further determine the impact mitigation action using the collision mitigation model. Further in this regard, the impact mitigation action can be determined (e.g., via the impact mitigation component 206) to minimize a likelihood of occurrence of the second collision with a group of objects comprising the object.

In various embodiments, the onboard vehicle system 104 can utilize one or more distance sensors 302 in order to determine three-dimensional positions of vehicles (e.g., vehicles other than the vehicle 102), pedestrians, or other objects relative to the vehicle 102 herein. In this regard, the onboard vehicle system 104 can utilize and/or integrate data from the distance sensors 302 to generate a three-dimensional digital representation surrounding the vehicle 102. In various implementations, the distance sensors 302 can comprise one or more of a light detection and ranging (lidar) sensor, a radar sensor, an ultrasonic sensor, an infrared sensor, a laser sensor, a light emitting diode (LED) sensor, a capacitive sensor, a time of flight sensor, a hall effect sensor, or an optical sensor. In some embodiments a plurality of optical sensors or other suitable sensors can be utilized to determine or triangulate positions of vehicles, pedestrians, or other objects relative to the vehicle 102 herein. Further, plurality of optical sensors or other suitable sensors can be utilized to determine shapes (e.g., shapes of other vehicles), which can be utilized (e.g., by the impact determination component) to determine a type, make, or model, or other suitable features or aspects of vehicles other than the vehicle 102.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (A.I.) model and/or machine learning (M.L.) or an M.L. model that can learn to perform the above or below described functions (e.g., via training using historical training data and/or feedback data).

In some embodiments, machine learning component 210 can comprise an A.I. and/or M.L. model that can be trained (e.g., via supervised and/or unsupervised techniques) to perform the above or below-described functions using historical training data comprising various context conditions that correspond to various augmented network optimization operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by the machine learning component 210. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, a machine learning component 210 herein can initiate an operation associated with determining various thresholds herein (e.g., a motion pattern thresholds, input pattern thresholds, similarity thresholds, authentication signal thresholds, audio frequency thresholds, or other suitable thresholds).

In an embodiment, the machine learning component 210 can perform a utility-based analysis that factors cost of initiating the above-described operations versus benefit. In this embodiment, the machine learning component 210 can use one or more additional context conditions to determine various thresholds herein.

To facilitate the above-described functions, a machine learning component 210 herein can perform classifications, correlations, inferences, and/or expressions associated with principles of artificial intelligence. For instance, the machine learning component 210 can employ an automatic classification system and/or an automatic classification. In one example, the machine learning component 210 can employ a probabilistic and/or statistical-based analysis (e.g., factoring into the analysis utilities and costs) to learn and/or generate inferences. The machine learning component 210 can employ any suitable machine-learning based techniques, statistical-based techniques and/or probabilistic-based techniques. For example, the machine learning component 210 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the machine learning component 210 can perform a set of machine-learning computations. For instance, the machine learning component 210 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

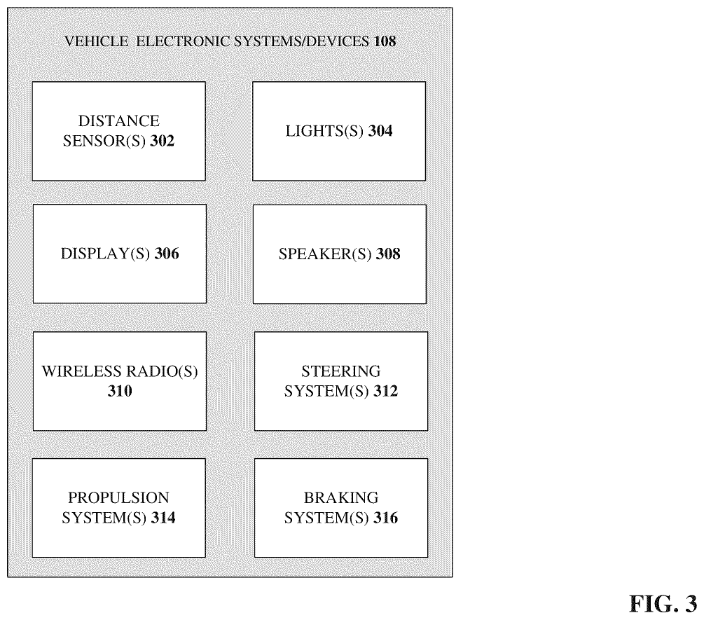

FIG. 3 illustrates a block diagram of example, non-limiting vehicle electronic systems/devices 108 in accordance with one or more embodiments described herein. Repetitive description of like elements employed in other embodiments described herein is omitted for sake of brevity. In various embodiments, the vehicle electronic systems/devices 108 can comprise one or more of distance sensors 302 (e.g., sensors external or internal to the vehicle 102 that are arranged to detect distance between the vehicle 102 and other objects (e.g., other vehicles, pedestrians, etc.) and/or to determine potential collisions, such as one or more of a light detection and ranging (lidar) sensor, a radar sensor, an ultrasonic sensor, an infrared sensor, a laser sensor, a light emitting diode (LED) sensor, a capacitive sensor, a time of flight sensor, a hall effect sensor, or an optical sensor, or another suitable sensors), light(s) 304, display(s) 306 (e.g., infotainment devices, touchscreen displays, etc.), speaker(s) 308, and/or wireless radio(s) 310. In various embodiments, the vehicle electronic systems/devices 108 can additionally, or alternatively comprise one or more of steering system(s) 312, propulsion system(s) 314, and/or braking system(s) 316. The steering system(s) 312 can comprise one or more of a steering wheel, steering column, steering gearbox, steering rack and pinion, pitman arm, idler arm, tie rod(s), steering knuckles, power steering pump or electric steering motor, vehicle wheels and tires, or other suitable steering system components. The propulsion system(s) 314 can comprise one or more of an engine, transmission, driveshaft, differential, axle(s), wheels/tires, traction inverter, electric motor, or other suitable propulsion system components. The braking system(s) 316 can comprise one or more of a brake pedal, brake booster, master cylinder, brake lines, brake calipers/pads, wheel cylinders and brake shoes, brake rotors or drums, brake fluid, electric vehicle propulsion components (e.g., for regenerative braking), or other suitable braking system components.

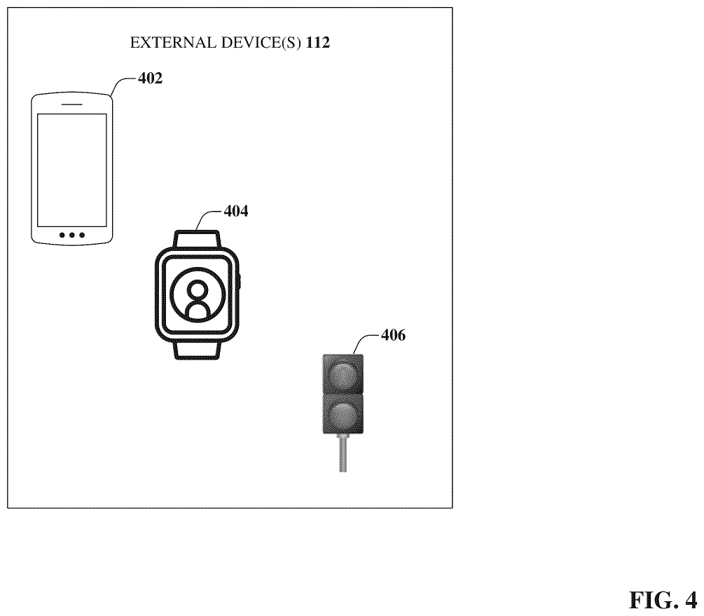

FIG. 4 illustrates a block diagram of example, non-limiting external devices 112 in accordance with one or more embodiments described herein. In this regard, the external devices 112 can comprise mobile device 402 (e.g., a smartphone), wearable device 404 (e.g., a smartwatch, headphones, augmented reality headset or glasses, virtual reality headset or glasses, mixed reality headset or glasses, smart ring, smart glasses, smart jewelry, smart clothing, fitness tracking device, or another suitable wearable device), a traffic signal 406 (e.g., a traffic light, cross walk signal, or another suitable traffic signal), or other suitable external devices.

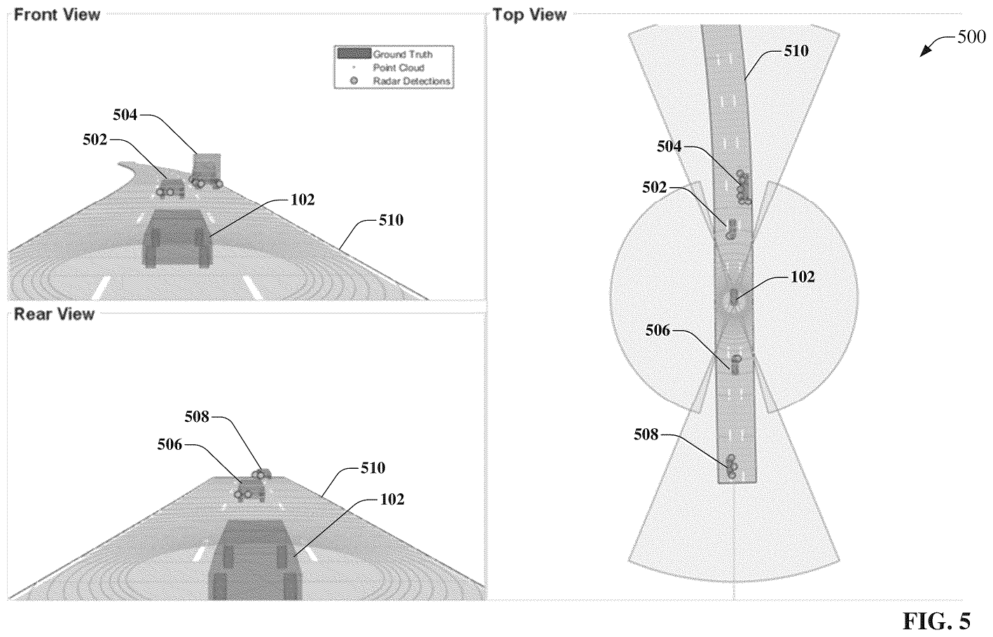

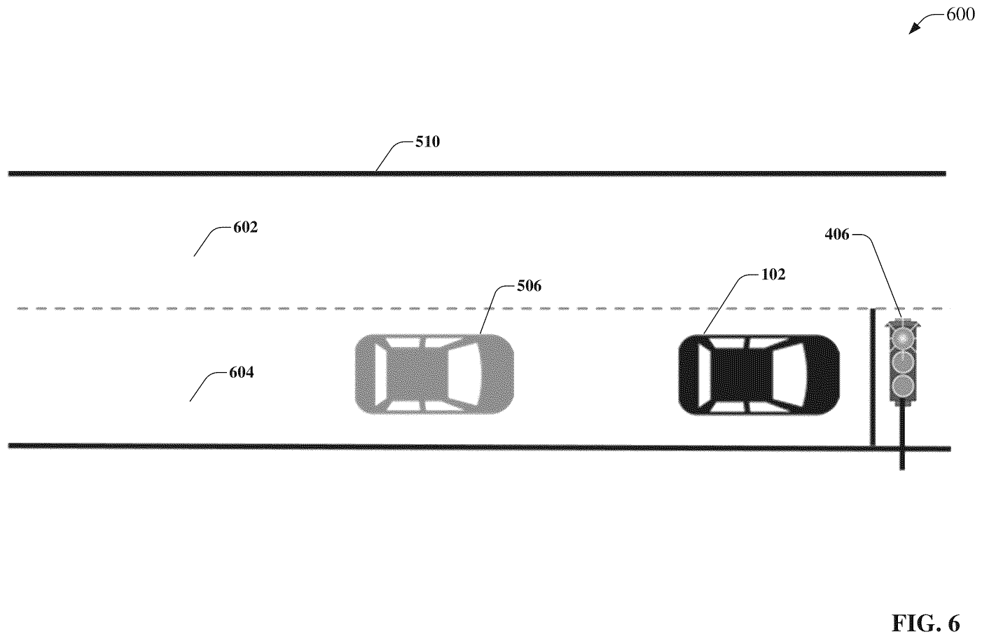

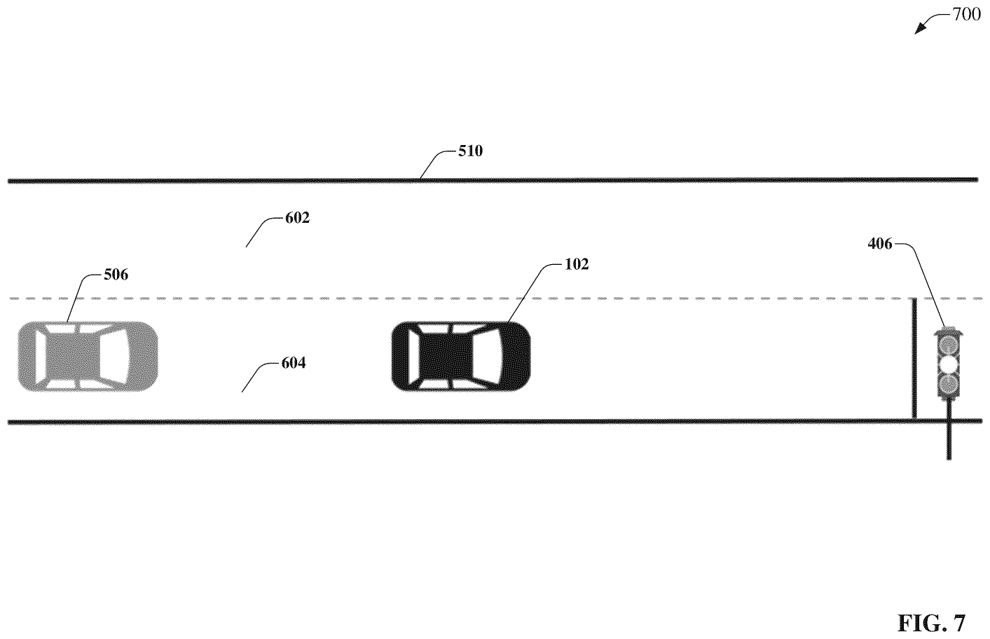

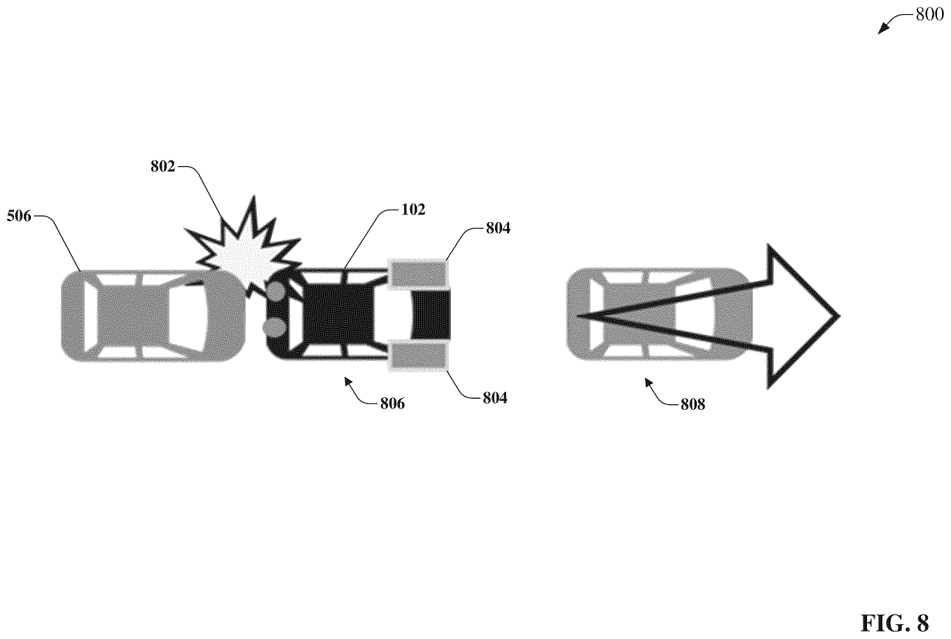

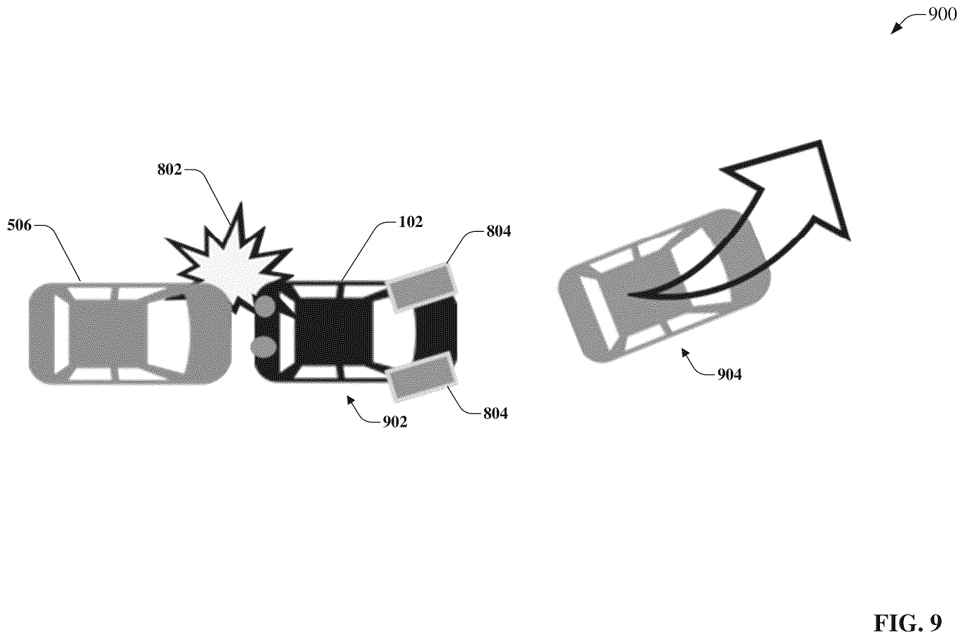

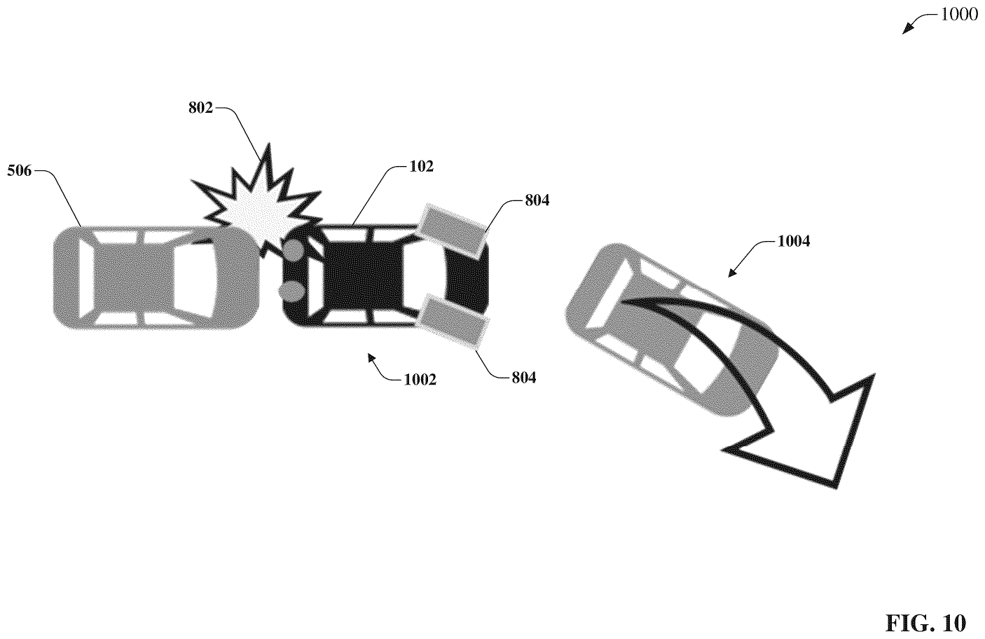

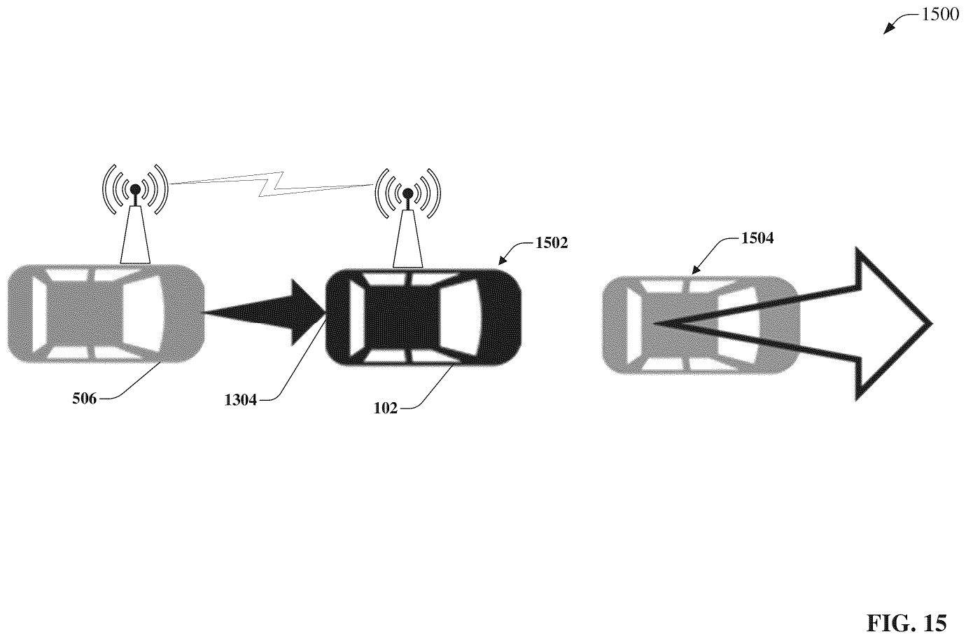

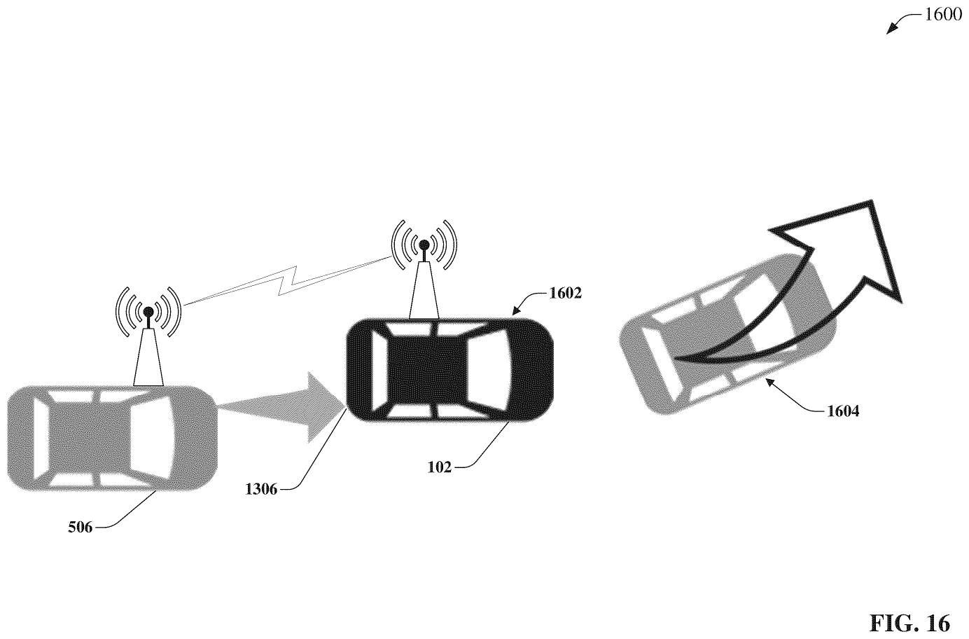

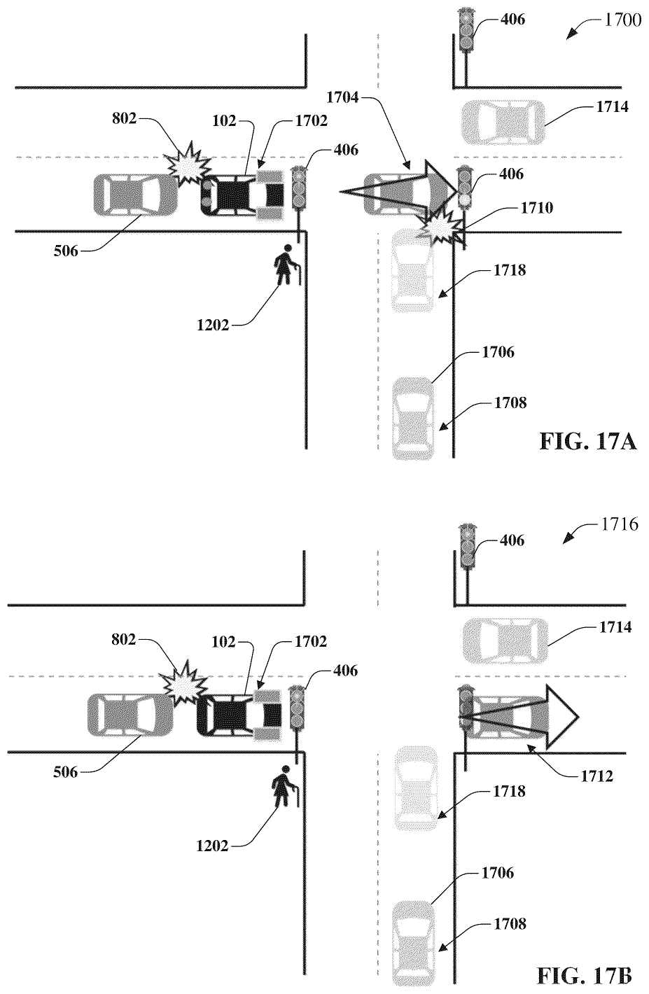

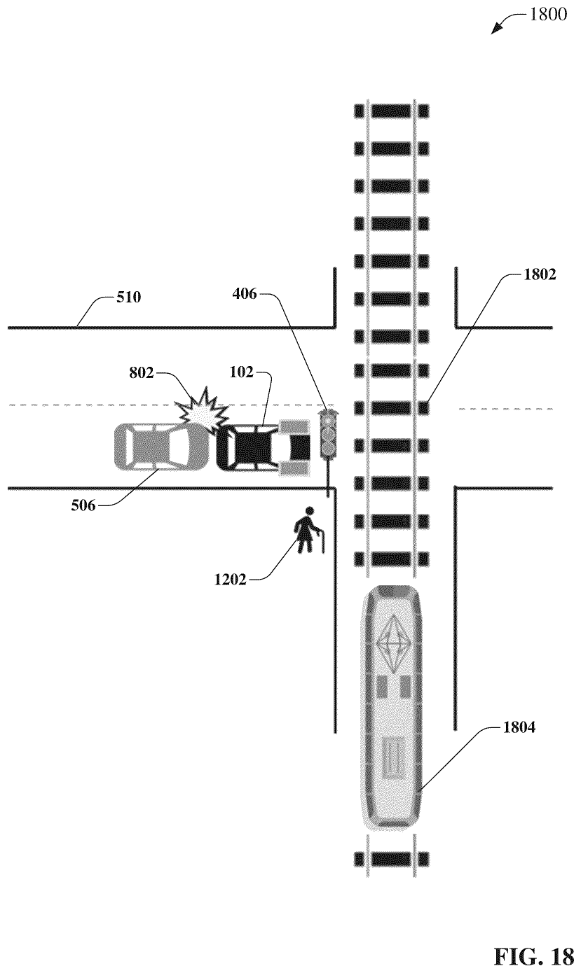

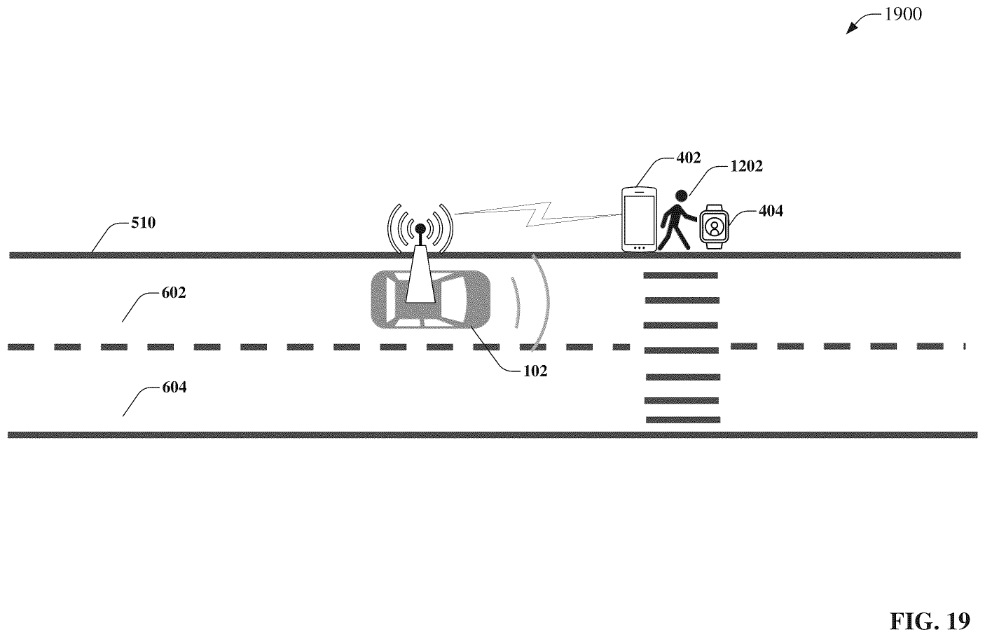

FIGS. 5-19 illustrate example, non-limiting scenarios and/or examples or embodiments in accordance with various embodiments described herein. In some embodiments, such scenarios can comprise a series of events or steps, however, the scenarios are presented in a non-limiting sequence and/or one or more steps or scenarios can be added, duplicated, omitted, etc.

Scenario 500 can comprise vehicle 102, vehicle 502 (e.g., an object herein), vehicle 504 (e.g., an object herein), vehicle 506 (e.g., an object herein), vehicle 508 (e.g., an object herein), and/or street 510. In scenario 500, the vehicle 102 (e.g., an autonomous vehicle) can utilize one or more of a variety of sensors (e.g., distance sensor(s) 302) to track speed and/or distance to other objects (e.g., vehicles and/or pedestrians) within a defined vicinity of the vehicle 102. A third party collision mitigation mode can be activated (e.g., via the primary impact determination component 202), for instance, when the vehicle 102 is in a driving (e.g., moving) state and other vehicles or pedestrians are detected (e.g., using the distance sensor(s) 302, which are typically active during operation of a vehicle 102 for other suitable navigational purposes) within a defined distance of the vehicle 102. With the third party collision mitigation mode inactive until an activation condition is satisfied, energy and/or computing resources (e.g., of the vehicle 102) can be saved until they are needed. In various embodiments, such an activation can comprise the vehicle 102 being determined (e.g., via the primary impact determination component 202) to perform one or more of slowing down, stopping, predicting to slow down/stop based on a trajectory and/or route of the vehicle 102 (e.g., when a risk of rear-end collisions increases).

In scenario 600, the vehicle 102 can be stationary (e.g., in lane 604 adjacent to oncoming lane 602) at a stop light (e.g., traffic signal 406). In this regard, the third party collision mitigation mode can be active (e.g., activated by the primary impact determination component 202 and/or alternate activation component 208). In scenario 700, the third party collision mitigation mode can be active (e.g., activated by the primary impact determination component 202 and/or alternate activation component 208) as soon as the vehicle 102 is determined to start to brake. The third party collision mitigation mode can additionally, or alternatively, be active (e.g., activated by the primary impact determination component 202 and/or alternate activation component 208) when the vehicle 102 anticipates (e.g., as determined via the primary impact determination component 202) that the vehicle 102 soon has to brake or slow down, for instance, when there is a yellow traffic light detected further ahead on the street 510, as in scenario 700.

In various embodiments herein, when the vehicle 102 determines (e.g., via the primary impact determination component 202) that there is a threshold possibility that it may be rear-ended (e.g., collision 802), the vehicle 102 can (e.g., via the impact mitigation component 206 and/or steering system(s) 312) turn a steering mechanism of the vehicle 102, based on its surroundings. The foregoing can prevent the vehicle 102 from being pushed into an object (e.g., third party) by the force of the rear-end collision (e.g., from vehicle 506). In scenario 800, the wheels 804 of the vehicle 102 can direct the vehicle 102 straight forward, relative to the vehicle 102, intended to enable the vehicle 102 to move from position 806 to position 808. In scenario 900, the wheels 804 of the vehicle 102 can direct the vehicle 102 to the left, relative to the vehicle 102, intended to enable the vehicle 102 to move from position 902 to position 904. In scenario 1000, the wheels 804 of the vehicle 102 can direct the vehicle 102 to the right, relative to the vehicle 102, intended to enable the vehicle 102 to move from position 1002 to position 1004.

In scenario 1100, the vehicle 102 is braking for an obstacle in the road. Vehicle 506 does not detect this braking in time to avoid a collision 802 with the vehicle 102. The third party collision mitigation mode of the vehicle 102 is active (e.g., activated by the primary impact determination component 202 and/or alternate activation component 208), and the primary impact determination component 202 has determined that a rear end collision 802, caused by the vehicle 506, is imminent. The secondary impact determination component 204 can determine that the vehicle 1102 is traveling toward the vehicle 102 an opposite direction (e.g., from position 1104 to position 1106). To avoid being pushed into the oncoming lane and potentially involve vehicle 1102 (e.g., a third party vehicle or object) in the accident, the vehicle 102 can turn (e.g., via the impact mitigation component 206 and/or steering system(s) 312) its wheels to the right, intended to enable the vehicle 102 to move from position 1002 at collision 802 to position 1104.

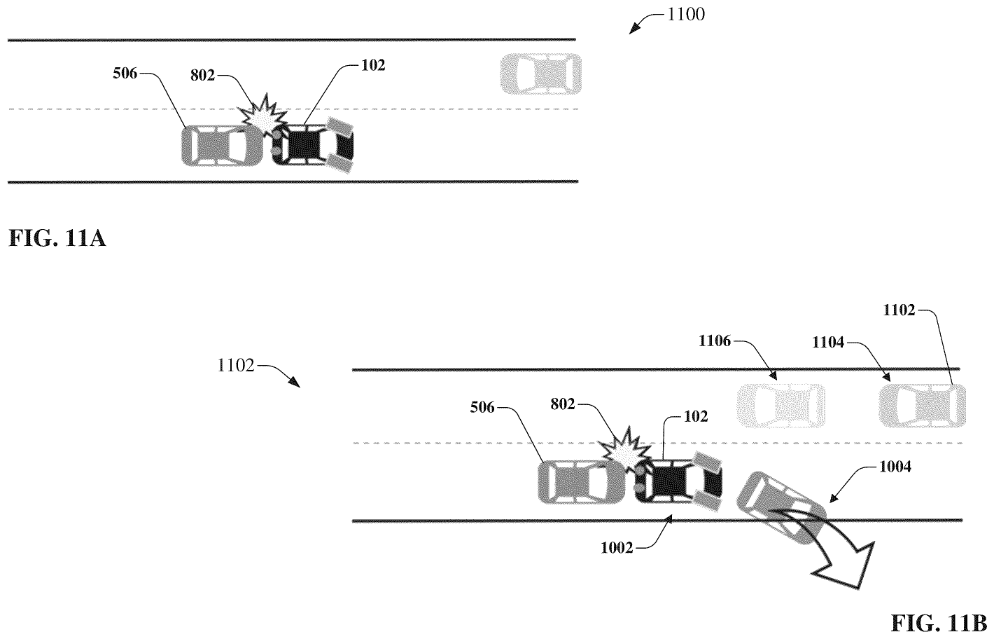

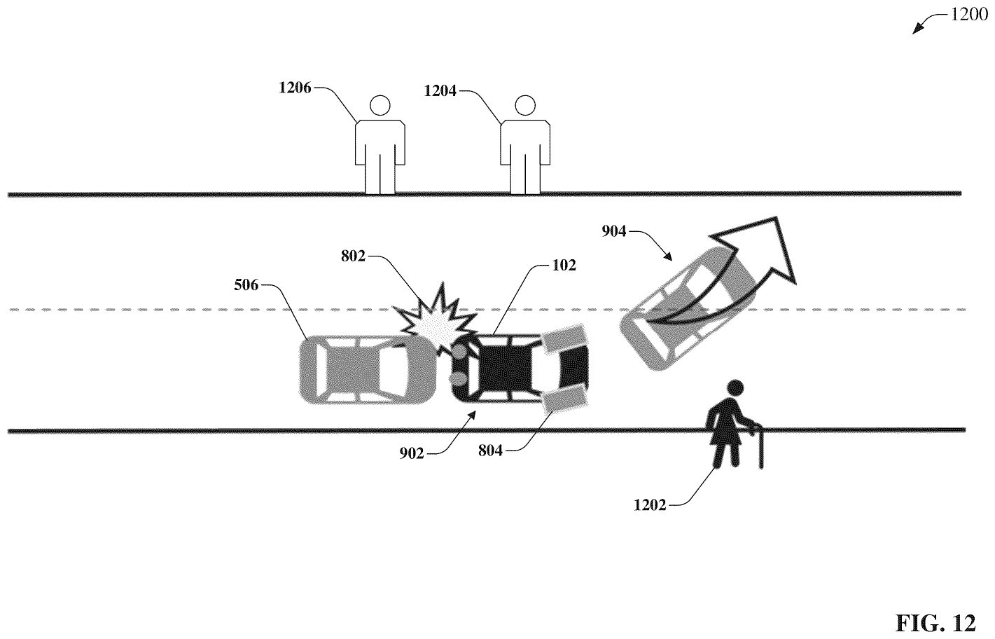

Similarly, in scenario 1200, there exists is a third-party vehicle in the oncoming lane (not depicted in FIG. 12) and also pedestrian 1202 on the sidewalk on the right side of the vehicle 102. The vehicle 102 can be configured to turn (e.g., via the impact mitigation component 206 and/or steering system(s) 312) its wheels to the left to avoid the pedestrian 1202 and/or pedestrians 1204 and 1206, even if it would cause the vehicle 102 to collide with vehicle 1102 (as in FIG. 11A or 11B), since the pedestrian 1202 (and/or pedestrians 1206 or 1204) is/are determined (e.g., via the impact mitigation component 206) to be the least protected object(s) of the potential third parties/objects (e.g., third parties comprising the vehicle 1102 and the pedestrians 1202, 1204, and 1206).

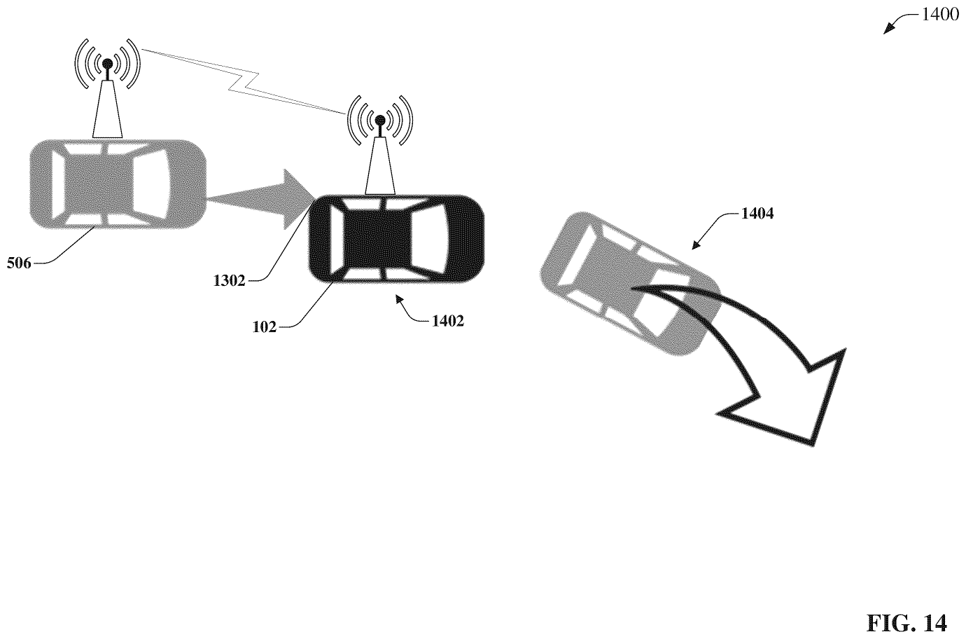

In FIG. 13, vehicle 102 is depicted. Vehicle 102 can comprise one or more of a variety of defined impact zones. For instance, vehicle 102 can comprise zone 1302 (e.g., a left side of the vehicle 102), zone 1304 (e.g., a middle of the vehicle 102), and/or zone 1306 (e.g., a right side of the vehicle 102). Though three impact zones are depicted in FIG. 13, vehicle 102 is not limited to comprising three impact zones, and any suitable quantity or size of impact zones are envisaged. As depicted in FIGS. 14-16, the zone at which the vehicle 102 is impacted by the vehicle 506 can influence a trajectory of the vehicle 102. In scenarios 1400-1600, exemplary vehicle to vehicle (V2V) communication (e.g., between vehicle 102 and vehicle 506) is utilized (e.g., via Bluetooth, 5G, 6G, cloud-based, or other suitable V2V or vehicle to everything (V2E) communication). If the primary impact determination component 202 determines that a collision between the vehicle 102 and the vehicle 506 is imminent (e.g., and cannot be avoided), the communication component 212 can send a request to the vehicle 506, requesting that the vehicle 506 strike the vehicle 102 in one of the impact zones depicted in FIG. 13. In other embodiments, the communication component 212 can send a request to the vehicle 506 to immediately initiate a braking action to avoid a collision with the vehicle 102. In scenario 1400, the impact mitigation component 206 can determine that moving from position 1402 at impact to position 1404 would mitigate involvement of a third party in the imminent collision. In this regard, the communication component 212 can send a request to the vehicle 506, prior to the collision, to strike the vehicle 102 in zone 1302. Similarly, in scenario 1500, the impact mitigation component 206 can determine that moving from position 1502 at impact to position 1504 would mitigate involvement of a third party in the imminent collision. In this regard, the communication component 212 can send a request to the vehicle 506, prior to the collision, to strike the vehicle 102 in zone 1304. Similarly, in scenario 1600, the impact mitigation component 206 can determine that moving from position 1602 at impact to position 1604 would mitigate involvement of a third party in the imminent collision. In this regard, the communication component 212 can send a request to the vehicle 506, prior to the collision, to strike the vehicle 102 in zone 1306.

In various embodiments, the vehicle 102 can engage or disengage its brakes and/or accelerate, depending on the surroundings (e.g., via the impact mitigation component 206, propulsion system (2) 314, and/or braking system(s) 316). For instance, in scenario 1700, the vehicle 102 is stopped at an intersection. The vehicle 102 detects (e.g., via primary impact determination component 202 and/or distance sensor(s) 302) vehicle 506 approaching from behind. The vehicle 102 locks (e.g., via the impact mitigation component 206 and/or braking systems(s) 316) its brakes and prepares the steering to be pointed (e.g., via the steering system(s) 312) away from the pedestrian 1202 and away from the vehicle 1714 in the oncoming lane. However, with engaged brakes, as in scenario 1700, the vehicle 102 could slide from position 1702 to position 1704, at which the vehicle 102 could collide with vehicle 1706 (e.g., resulting in collision 1710), moving from position 1708 to position 1718 as a result of the vehicle 102 sliding into the intersection. To avoid this, in scenario 1716, the vehicle 102 can disengage (e.g., via the impact mitigation component 206 and/or braking systems(s) 316) its brakes and/or accelerate (e.g., via the impact mitigation component 206 and/or propulsion systems(s) 314) before and/or after being struck been the vehicle 506, for instance, to avoid the involvement of the vehicle 1706 in the accident (e.g., move from position 1702 to position 1712).

In various embodiments, the vehicle 102 can accelerate (e.g., via the impact mitigation component 206 and/or propulsion systems(s) 314) before and/or after a rear-ending has occurred or is about to occur (e.g., as determined or predicted via the secondary impact determination component 204). For example, in scenario 1800, the vehicle 102 stopped, or is slowly approaching a railway crossing 1802. It is noted that the railway crossing 1802 can comprise level-crossing barriers and lights, or only lights. Because the vehicle 102 being pushed onto rail tracks can be dangerous due to the potential collision with train 1804, the vehicle 102 can determine (e.g., via the impact mitigation component 206) to accelerate to try to avoid being hit by the train 1804. The impact mitigation component 206 can make such a determination based on one or more of vehicle 506 speed and/or distance relative to vehicle 102, train 1804 speed and/or distance relative to the vehicle 102, width of train tracks or rails, quantity of train tracks or rails, acceleration capability of the vehicle 102, road conditions such as rain, ice, snow, etc. If the collision 802 occurs, and the vehicle 102 is pushed onto the railway track, the vehicle 102 can attempt to move (e.g., via the impact mitigation component 206 and/or propulsion systems(s) 314) from the tracks to avoid the involvement of a third party/object (e.g., train 1804 in scenario 1800).

Scenario 1900 depicts an alert transmitted (e.g., via the communication component 212) to a wearable device 404 or mobile device 402 applicable to a pedestrian 1202 or another person. In this regard, the impact mitigation action can comprise transmission (e.g., via the communication component 212) of the alert. It is noted that, in various implementations, the mobile device 402 can be configured to display a visual representation of the alert, for instance, if a screen of the mobile device 402 is unlocked when the alert data is received by the mobile device 402. However, the mobile device 402 can be configured not to display a visual representation of the alert, for instance, if a screen of the mobile device 402 is locked when the alert data is received by the mobile device 402. In this regard, the mobile device 402 can, in some implementations, generate an audible alert based on the alert data regardless of whether the screen of the mobile device 402 is unlocked, though in other implementations, the mobile device 402 can be configured not to generate the audible alert, for instance, if a screen of the mobile device 402 is locked when the alert data is received by the mobile device 402.

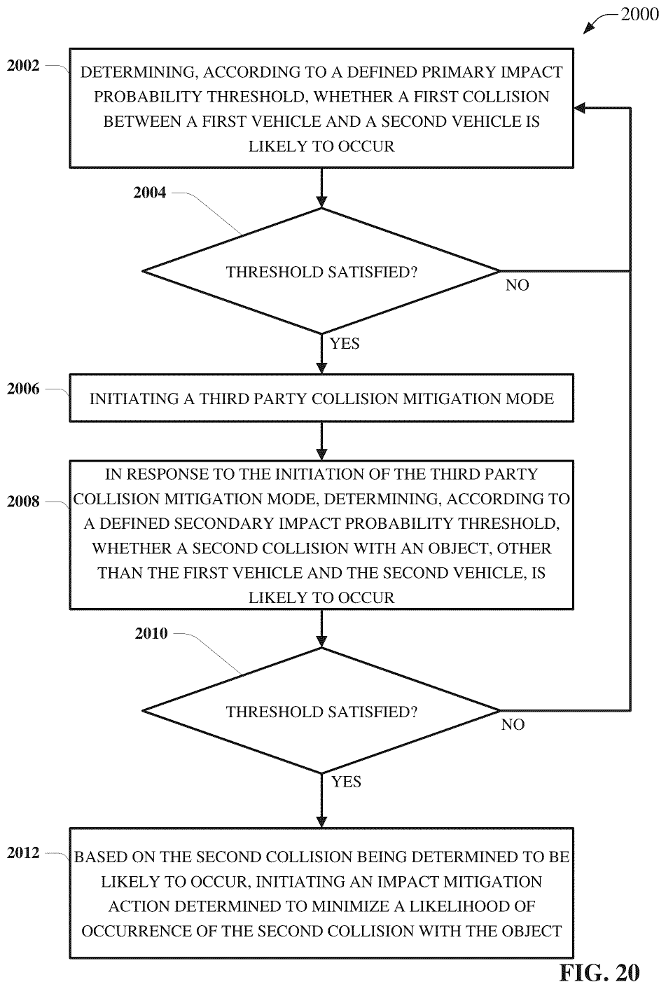

FIG. 20 illustrates a block flow diagram for a process 2000 associated with mitigation of third-party involvement in a rear-end collision in accordance with one or more embodiments described herein. At 2002, the process 2000 can comprise determining (e.g., via a primary impact determination component 202 according to a defined primary impact probability threshold) whether a first collision between a first vehicle (e.g., vehicle 102) and a second vehicle (e.g., vehicle 506) is likely to occur. At 2004, if the defined primary impact probability threshold (e.g., regarding a likelihood of a first collision between the first vehicle and the second vehicle) is satisfied, the process can proceed to 2006. Otherwise, the process can return to 2002. At 2006, the process 2000 can comprise initiating (e.g., via the primary impact determination component 202) a third party collision mitigation mode. At 2008, the process 2000 can comprise, in response to the initiation of the third party collision mitigation mode, determining (e.g., via the secondary impact determination component 204 according to a defined secondary impact probability threshold) whether a second collision with an object, other than the first vehicle (e.g., vehicle 102) and the second vehicle (e.g., vehicle 506), is likely to occur. At 2010, if the defined secondary impact probability threshold (e.g., regarding a likelihood of a second collision between the first vehicle and an object) is satisfied, the process can proceed to 2012. Otherwise, the process can return to 2002. At 2012, the process 2000 can comprise, based on the second collision being determined (e.g., via the secondary impact determination component 204) to be likely to occur, initiating (e.g., via the impact mitigation component 206) an impact mitigation action determined (e.g., via the impact mitigation component 206) to minimize a likelihood of occurrence of the second collision with the object.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 116 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

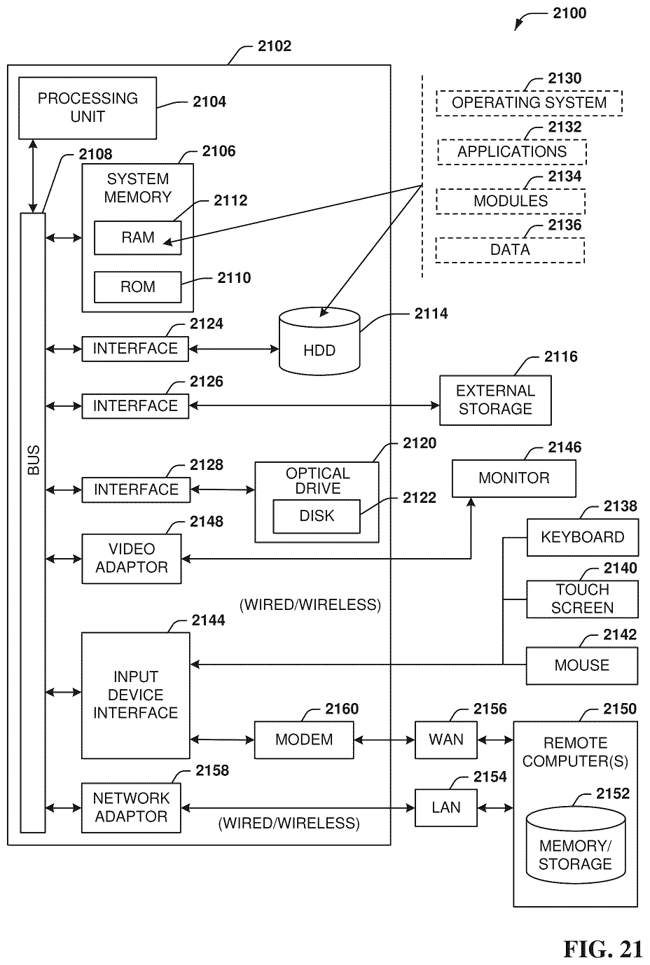

In order to provide additional context for various embodiments described herein, FIG. 21 and the following discussion are intended to provide a brief, general description of a suitable computing environment 2100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 21, the example environment 2100 for implementing various embodiments of the aspects described herein includes a computer 2102, the computer 2102 including a processing unit 2104, a system memory 2106 and a system bus 2108. The system bus 2108 couples system components including, but not limited to, the system memory 2106 to the processing unit 2104. The processing unit 2104 can be any of various commercially available processors, field-programmable gate array, AI accelerator application-specific integrated circuit, or other suitable processors. Dual microprocessors and other multi-processor architectures can also be employed as the processing unit 2104.

The system bus 2108 can be any of several types of bus structure that can further interconnect to a memory bus (with or without a memory controller), a peripheral bus, and a local bus using any of a variety of commercially available bus architectures. The system memory 2106 includes ROM 2110 and RAM 2112. A basic input/output system (BIOS) can be stored in a non-volatile memory such as ROM, erasable programmable read only memory (EPROM), EEPROM, which BIOS contains the basic routines that help to transfer information between elements within the computer 2102, such as during startup. The RAM 2112 can also include a high-speed RAM such as static RAM for caching data. It is noted that unified Extensible Firmware Interface(s) can be utilized herein.

The computer 2102 further includes an internal hard disk drive (HDD) 2114 (e.g., EIDE, SATA), one or more external storage devices 2116 (e.g., a magnetic floppy disk drive (FDD) 2116, a memory stick or flash drive reader, a memory card reader, etc.) and an optical disk drive 2120 (e.g., which can read or write from a CD-ROM disc, a DVD, a BD, etc.). While the internal HDD 2114 is illustrated as located within the computer 2102, the internal HDD 2114 can also be configured for external use in a suitable chassis (not shown). Additionally, while not shown in environment 2100, a solid-state drive (SSD) could be used in addition to, or in place of, an HDD 2114. The HDD 2114, external storage device(s) 2116 and optical disk drive 2120 can be connected to the system bus 2108 by an HDD interface 2124, an external storage interface 2126 and an optical drive interface 2128, respectively. The interface 2124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. The systems and methods described herein can be implemented utilizing various commercially available operating systems or combinations of operating systems.

Computer 2102 can optionally comprise emulation technologies. For example, a hypervisor (not shown) or other intermediary can emulate a hardware environment for operating system 2130, and the emulated hardware can optionally be different from the hardware illustrated in FIG. 21. In such an embodiment, operating system 2130 can comprise one virtual machine (VM) of multiple VMs hosted at computer 2102. Furthermore, operating system 2130 can provide runtime environments, such as the Java runtime environment or the .NET framework, for applications 2132. Runtime environments are consistent execution environments that allow applications 2132 to run on any operating system that includes the runtime environment. Similarly, operating system 2130 can support containers, and applications 2132 can be in the form of containers, which are lightweight, standalone, executable packages of software that include, e.g., code, runtime, system tools, system libraries and settings for an application.

Further, computer 2102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 2102. e.g., applied at the application execution level or at the operating system (OS) kernel level, thereby enabling security at any level of code execution.

A user can enter commands and information into the computer 2102 through one or more wired/wireless input devices, e.g., a keyboard 2138, a touch screen 2140, and a pointing device, such as a mouse 2142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2104 through an input device interface 2144 that can be coupled to the system bus 2108, but can be connected by other interfaces, such as a parallel port, an IEEE 1394 serial port, a game port, a USB port, an IR interface, a BLUETOOTH® interface, etc.

A monitor 2146 or other type of display device can be also connected to the system bus 2108 via an interface, such as a video adapter 2148. In addition to the monitor 2146, a computer typically includes other peripheral output devices (not shown), such as speakers, printers, etc.

The computer 2102 can operate in a networked environment using logical connections via wired and/or wireless communications to one or more remote computers, such as a remote computer(s) 2150. The remote computer(s) 2150 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2152 is illustrated. The logical connections depicted include wired/wireless connectivity to a local area network (LAN) 2154 and/or larger networks, e.g., a wide area network (WAN) 2156. Such LAN and WAN networking environments are commonplace in offices and companies, and facilitate enterprise-wide computer networks, such as intranets, all of which can connect to a global communications network, e.g., the Internet.

When used in a LAN networking environment, the computer 2102 can be connected to the local network 2154 through a wired and/or wireless communication network interface or adapter 2158. The adapter 2158 can facilitate wired or wireless communication to the LAN 2154, which can also include a wireless access point (AP) disposed thereon for communicating with the adapter 2158 in a wireless mode.

When used in a WAN networking environment, the computer 2102 can include a modem 2160 or can be connected to a communications server on the WAN 2156 via other means for establishing communications over the WAN 2156, such as by way of the Internet. The modem 2160, which can be internal or external and a wired or wireless device, can be connected to the system bus 2108 via the input device interface 2144. In a networked environment, program modules depicted relative to the computer 2102 or portions thereof, can be stored in the remote memory/storage device 2152. It will be appreciated that the network connections shown are example and other means of establishing a communications link between the computers can be used.

When used in either a LAN or WAN networking environment, the computer 2102 can access cloud storage systems or other network-based storage systems in addition to, or in place of, external storage devices 2116 as described above. Generally, a connection between the computer 2102 and a cloud storage system can be established over a LAN 2154 or WAN 2156 e.g., by the adapter 2158 or modem 2160, respectively. Upon connecting the computer 2102 to an associated cloud storage system, the external storage interface 2126 can, with the aid of the adapter 2158 and/or modem 2160, manage storage provided by the cloud storage system as it would other types of external storage. For instance, the external storage interface 2126 can be configured to provide access to cloud storage sources as if those sources were physically connected to the computer 2102.

The computer 2102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

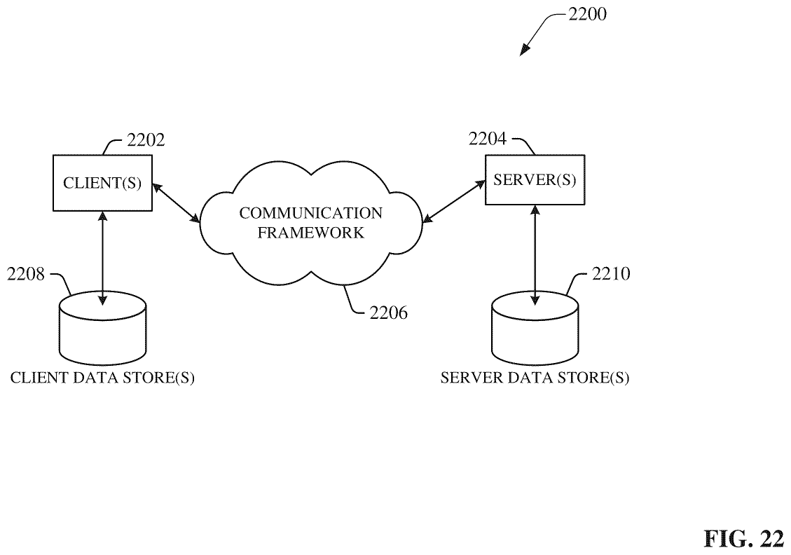

Referring now to FIG. 22, there is illustrated a schematic block diagram of a computing environment 2200 in accordance with this specification. The system 2200 includes one or more client(s) 2202, (e.g., computers, smart phones, tablets, cameras, PDA's). The client(s) 2202 can be hardware and/or software (e.g., threads, processes, computing devices). The client(s) 2202 can house cookie(s) and/or associated contextual information by employing the specification, for example.

The system 2200 also includes one or more server(s) 2204. The server(s) 2204 can also be hardware or hardware in combination with software (e.g., threads, processes, computing devices). The servers 2204 can house threads to perform transformations of media items by employing aspects of this disclosure, for example. One possible communication between a client 2202 and a server 2204 can be in the form of a data packet adapted to be transmitted between two or more computer processes wherein data packets may include coded analyzed headspaces and/or input. The data packet can include a cookie and/or associated contextual information, for example. The system 2200 includes a communication framework 2206 (e.g., a global communication network such as the Internet) that can be employed to facilitate communications between the client(s) 2202 and the server(s) 2204.

Communications can be facilitated via a wired (including optical fiber) and/or wireless technology. The client(s) 2202 are operatively connected to one or more client data store(s) 2208 that can be employed to store information local to the client(s) 2202 (e.g., cookie(s) and/or associated contextual information). Similarly, the server(s) 2204 are operatively connected to one or more server data store(s) 2210 that can be employed to store information local to the servers 2204. Further, the client(s) 2202 can be operatively connected to one or more server data store(s) 2210.

In one exemplary implementation, a client 2202 can transfer an encoded file, (e.g., encoded media item), to server 2204. Server 2204 can store the file, decode the file, or transmit the file to another client 2202. It is noted that a client 2202 can also transfer uncompressed file to a server 2204 and server 2204 can compress the file and/or transform the file in accordance with this disclosure. Likewise, server 2204 can encode information and transmit the information via communication framework 2206 to one or more clients 2202.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:

1. A system, comprising:
a memory that stores computer executable components; and
a processor that executes the computer executable components stored in the memory, wherein the computer executable components comprise:
a primary impact determination component that, based upon a determination, according to a defined primary impact probability threshold, that a first collision between a first vehicle and a second vehicle is likely to occur, activates a third party collision mitigation mode;
a secondary impact determination component that, in response to the activation of the third party collision mitigation mode, determines, according to a defined secondary impact probability threshold, whether a second collision with an object, other than the first vehicle and the second vehicle, is likely to occur; and
an impact mitigation component that, based on the second collision being determined to be likely to occur, facilitates an impact mitigation action determined to minimize a likelihood of occurrence of the second collision with the object.

2. The system of any preceding clause, wherein the computer executable components further comprise:
an alternate activation component that activates the third party collision mitigation mode in response to an alternate activation condition being determined to be satisfied.

3. The system of any preceding clause, wherein the alternate activation condition comprises a deceleration of the first vehicle.

4. The system of any preceding clause, wherein the alternate activation condition comprises the first vehicle being determined to be within a threshold distance of a defined location.

5. The system of any preceding clause, wherein the alternate activation condition comprises the first vehicle being determined, according to a defined braking probability threshold, to be likely to initiate a future braking action.

6. The system of any preceding clause, wherein the impact mitigation action comprises adjustment of a steering mechanism of the first vehicle to facilitate a predicted trajectory away from the object.

7. The system of any preceding clause, wherein the object comprises a first object, and wherein the predicted trajectory is predicted to avoid the first object and a second object, other than the first object.

8. The system of any preceding clause, wherein the object comprises a third vehicle, other than the first vehicle and other than the second vehicle.

9. The system of any preceding clause, wherein the object comprises a pedestrian.

10. The system of any preceding clause, wherein the computer executable components further comprise:
a communication component that, based on the first collision and the second collision being determined to be likely to occur, transmits request data, representative of a collision request, from the first vehicle to the second vehicle, wherein the collision request comprises a request for the second vehicle to contact the first vehicle at a designated zone of a plurality of zones of the first vehicle.

11. The system of any preceding clause, wherein the impact mitigation action comprises disengagement of a braking system of the first vehicle.

12. The system of any preceding clause, wherein the impact mitigation action comprises an acceleration of the first vehicle.

13. The system of any preceding clause, wherein the impact mitigation action comprises movement of the first vehicle away from a defined area.

14. The system of any preceding clause, wherein the computer executable components further comprise:
a communication component that, based on the second collision being determined to be likely to occur, transmits alert data representative of an alert to a mobile device associated with the object, wherein the impact mitigation action comprises transmission of the alert.

15. The system of any preceding clause, wherein the computer executable components further comprise:
a communication component that, based on the second collision being determined to be likely to occur, transmits alert data representative of an alert to a traffic signal applicable to the object.

16. The system of claim 1, wherein the computer executable components further comprise:
a machine learning component that, using machine learning applied to past first collusions other than the first collision or to past second collisions other than the second collision, generates a collision mitigation model, wherein the impact mitigation component further determines the impact mitigation action using the collision mitigation model, and wherein the impact mitigation action is determined to minimize a likelihood of occurrence of the second collision with a group of objects comprising the object.

17. The system of clause 1 above with any set of combinations of the systems 2-16 above.

18. A non-transitory machine-readable medium, comprising executable instructions that, when executed by a processor, facilitate performance of operations, comprising:
based upon a determination, according to a defined primary impact probability threshold, that a first collision between a first vehicle and a second vehicle is likely to occur, initiating a third party collision mitigation mode;
in response to the initiation of the third party collision mitigation mode, determining, according to a defined secondary impact probability threshold, whether a second collision with an object, other than the first vehicle and the second vehicle, is likely to occur; and
based on the second collision being determined to be likely to occur, initiating an impact mitigation action determined to minimize a likelihood of occurrence of the second collision with the object.

19. The non-transitory machine-readable medium of any preceding clause, wherein the operations further comprise:
initiating the third party collision mitigation mode in response to an alternate initiation condition being determined to be satisfied, wherein the alternate initiation condition is based on a defined route applicable to the first vehicle.

20. A method, comprising:
based upon a determination, according to a defined primary impact probability threshold, that a first collision between a first vehicle and a second vehicle is likely to occur, activating, by a system comprising a processor, a third party collision mitigation mode;
in response to the activation of the third party collision mitigation mode, determining, by the system and according to a defined secondary impact probability threshold, whether a second collision with an object, other than the first vehicle and the second vehicle, is likely to occur; and
based on the second collision being determined to be likely to occur, facilitating, by the system, an impact mitigation action determined to minimize a likelihood of occurrence of the second collision with the object.

21. The method of any preceding clause, wherein the object comprises a pedestrian, and wherein the impact mitigation action comprises an alert transmitted to a wearable device applicable to the pedestrian.

What is claimed is:

1. A system, comprising:
a memory that stores computer executable components; and
a processor that executes the computer executable components stored in the memory, wherein the computer executable components comprise:
a primary impact determination component that, based upon a determination, according to a defined primary impact probability threshold, that a first collision between a first vehicle and a second vehicle is likely to occur, activates a third party collision mitigation mode;
a secondary impact determination component that, in response to the activation of the third party collision mitigation mode, determines, according to a defined secondary impact probability threshold, whether a second collision with an object, other than the first vehicle and the second vehicle, is likely to occur; and
an impact mitigation component that, based on the second collision being determined to be likely to occur, facilitates an impact mitigation action determined to minimize a likelihood of occurrence of the second collision with the object.

2. The system of claim 1, wherein the computer executable components further comprise:
an alternate activation component that activates the third party collision mitigation mode in response to an alternate activation condition being determined to be satisfied.

3. The system of claim 2, wherein the alternate activation condition comprises a deceleration of the first vehicle.

4. The system of claim 2, wherein the alternate activation condition comprises the first vehicle being determined to be within a threshold distance of a defined location.

5. The system of claim 2, wherein the alternate activation condition comprises the first vehicle being determined, according to a defined braking probability threshold, to be likely to initiate a future braking action.

6. The system of claim 1, wherein the impact mitigation action comprises adjustment of a steering mechanism of the first vehicle to facilitate a predicted trajectory away from the object.

7. The system of claim 6, wherein the object comprises a first object, and wherein the predicted trajectory is predicted to avoid the first object and a second object, other than the first object.

8. The system of claim 1, wherein the object comprises a third vehicle, other than the first vehicle and other than the second vehicle.

9. The system of claim 1, wherein the object comprises a pedestrian.

10. The system of claim 1, wherein the computer executable components further comprise:
a communication component that, based on the first collision and the second collision being determined to be likely to occur, transmits request data, representative of a collision request, from the first vehicle to the second vehicle, wherein the collision request comprises a request for the second vehicle to contact the first vehicle at a designated zone of a plurality of zones of the first vehicle.

11. The system of claim 1, wherein the impact mitigation action comprises disengagement of a braking system of the first vehicle.

12. The system of claim 1, wherein the impact mitigation action comprises an acceleration of the first vehicle.

13. The system of claim 1, wherein the impact mitigation action comprises movement of the first vehicle away from a defined area.

14. The system of claim 1, wherein the computer executable components further comprise:
a communication component that, based on the second collision being determined to be likely to occur, transmits alert data representative of an alert to a mobile device associated with the object, wherein the impact mitigation action comprises transmission of the alert.

15. The system of claim 1, wherein the computer executable components further comprise:
a communication component that, based on the second collision being determined to be likely to occur, transmits alert data representative of an alert to a traffic signal applicable to the object.

16. The system of claim 1, wherein the computer executable components further comprise:
a machine learning component that, using machine learning applied to past first collusions other than the first collision or to past second collisions other than the second collision, generates a collision mitigation model, wherein the impact mitigation component further determines the impact mitigation action using the collision mitigation model, and wherein the impact mitigation action is determined to minimize a likelihood of occurrence of the second collision with a group of objects comprising the object.

17. A non-transitory machine-readable medium, comprising executable instructions that, when executed by a processor, facilitate performance of operations, comprising:
based upon a determination, according to a defined primary impact probability threshold, that a first collision between a first vehicle and a second vehicle is likely to occur, initiating a third party collision mitigation mode;
in response to the initiation of the third party collision mitigation mode, determining, according to a defined secondary impact probability threshold, whether a second collision with an object, other than the first vehicle and the second vehicle, is likely to occur; and
based on the second collision being determined to be likely to occur, initiating an impact mitigation action determined to minimize a likelihood of occurrence of the second collision with the object.

18. The non-transitory machine-readable medium of claim 17, wherein the operations further comprise:
initiating the third party collision mitigation mode in response to an alternate initiation condition being determined to be satisfied, wherein the alternate initiation condition is based on a defined route applicable to the first vehicle.

19. A method, comprising:
based upon a determination, according to a defined primary impact probability threshold, that a first collision between a first vehicle and a second vehicle is likely to occur, activating, by a system comprising a processor, a third party collision mitigation mode;
in response to the activation of the third party collision mitigation mode, determining, by the system and according to a defined secondary impact probability threshold, whether a second collision with an object, other than the first vehicle and the second vehicle, is likely to occur; and
based on the second collision being determined to be likely to occur, facilitating, by the system, an impact mitigation action determined to minimize a likelihood of occurrence of the second collision with the object.

20. The method of claim 19, wherein the object comprises a pedestrian, and wherein the impact mitigation action comprises an alert transmitted to a wearable device applicable to the pedestrian.
